(19) United States
(12) Patent Application Publication
(10) Pub. No.: US 2005/0111355 A1
(43) Pub. Date: May 26, 2005

(54) Managing timers

(76) Inventors: Eric Plaks, Escondido, CA (US); Yunhong Li, San Diego, CA (US)

Correspondence Address: FISH & RICHARDSON, PC, 12390 EL CAMINO REAL, SAN DIEGO, CA, 92130-2081, US

(21) Appl. No.: 10/719,669

(22) Filed: Nov. 20, 2003

(51) Int. Cl. H04L 12/28

(52) U.S. Cl. 370/229; 370/412

(57) ABSTRACT

A timer is installed by writing a status bit into a first table indexed by a first pointer, and writing a value corresponding to timer information into a second table indexed by the first pointer.

### BACKGROUND

Some systems (e.g., communication systems, data processing systems, etc.) distribute data in packets for transmitting the data over a network such as a local area network (LAN), a wide area network (WAN), and so forth. A processor running a networking application may handle packets for a large number of simultaneous connections. In some networking protocols, such as transmission control protocol (TCP), maintaining connections includes managing timers for the connections. Timers are used, for example, to keep track of a time period for receiving an acknowledgement of receipt of a data packet. The large number of connections leads to a large number of timers to manage.

### DESCRIPTION OF DRAWINGS

FIG. 1 is a block diagram depicting a system for transferring data packets between a WAN network and a LAN network.

FIG. 2 is a diagram depicting data structures for managing timers.

FIG. 3 is a flowchart for a timer installation process.

FIG. 4 is a flowchart for a timeout process.

FIG. 5 is a flowchart for a timer canceling process.

### DESCRIPTION

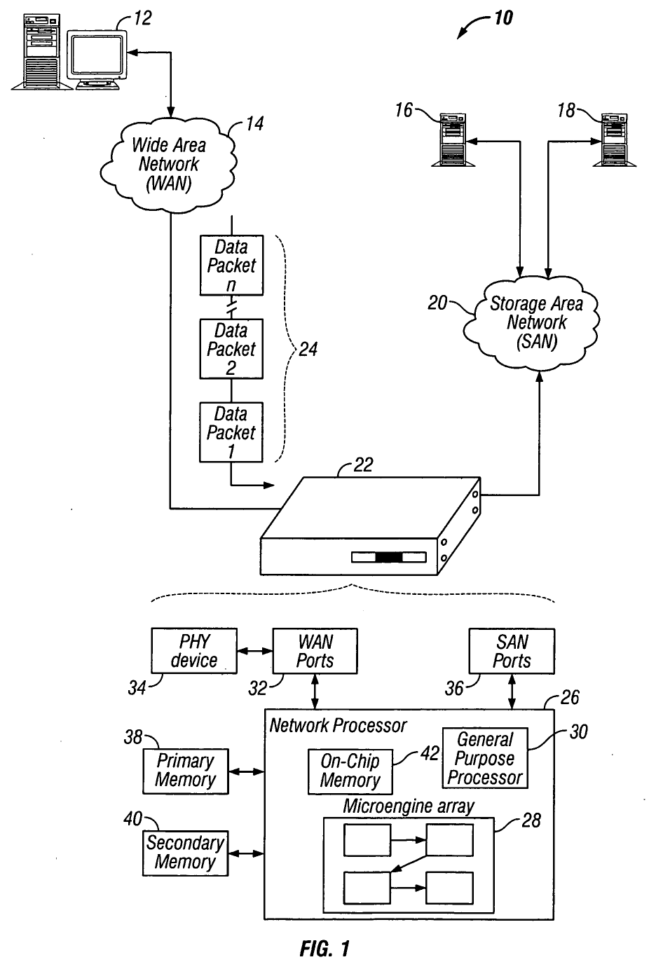

Referring to FIG. 1, a system 10 for storing data from a computer system 12 in storage systems 16, 18 via a wide area network (WAN) 14 and a storage area network (SAN) 20 includes a network device 22 (e.g., a server or switch) that collects a stream of “n” data packets 24, and directs the data through the SAN 20 for storage in the appropriate storage system 16 or storage system 18. The network device 22 includes a network processor 26 that processes the data packet stream 24.

In this example, the network processor 26 includes a plurality of, e.g., four programmable multithreaded microengines 28. Each microengine executes instructions that are associated with an instruction set (e.g., a reduced instruction set computer (RISC) architecture) used by the array of microengines 28 included in the network processor 26. Since the instruction set is designed for specific use by the array of microengines 28, instructions are processed relatively quickly compared to the number clock cycles typically needed to execute instructions associated with a general-purpose processor.

Each one of the microengines included in the array of microengines 28 has a relatively simple architecture and quickly executes relatively routine processes (e.g., TCP processes that handle a stream of data packets) while leaving more complicated processing to other processing units such as a general-purpose processor 30 (e.g., a StrongArm processor of ARM Limited, United Kingdom) also included in the network processor 26.

Typically the data packets are received by the network device 22 on one or more WAN ports 32 that provide a physical link to the WAN 14 and are passed to the network processor 26 that controls the entering of the incoming data packets. A WAN port is connected to a physical layer device 34 (e.g., a wired or wireless PHY device) that interfaces with a transmission medium connecting to the WAN 14. The SAN ports 36, which are also in communication with the network processor 26, are used for transmission of the data to the SAN 20 for reception at the appropriate storage system 16 or 18.

Each data packet is associated with a logical connection between a source (e.g., computer system 12) and a destination host (e.g., network device 22). For example, the connection uses a “datagram service” that allows data packets associated with the same connection to travel over different physical routes through a network from the source to the destination. A packet includes an address that is used to route the packet over the WAN 14 to the host.

The microengine array 28 can be used for a TCP offload engine (TOE). The TCP offload engine handles tasks associated with the TCP protocol reducing the processing burden on the general-purpose processor 30. One of the processing tasks associated with the TCP protocol is managing a “Delayed Ack” timer for a network connection. The Delayed Ack timer is a timer for delaying the transmission of a packet that acknowledges the receipt of a prior packet, potentially reducing the overall number of acknowledgement packets that are sent and the associated overhead. The TCP offload engine is used by a host, such as the network device 22, that uses TCP along with internet protocol (IP) for segmenting data into packets, and sending and receiving the packets reliably.

While handling a potentially large number of connections, the network processor 26 writes to and reads from storage devices such as a primary memory 38 (e.g., SRAM) and a secondary memory 40 (e.g., DRAM) which are in communication with the network processor 26. The primary memory 38 can provide faster access time, and the secondary memory 40 can provide larger storage space. The network processor 26 also includes a small on-chip memory 42 that can be used, for example, to cache portions of the primary memory 38 and the secondary memory 40. The network processor 26 uses these memory resources to manage timers for each of the connections that it handles.

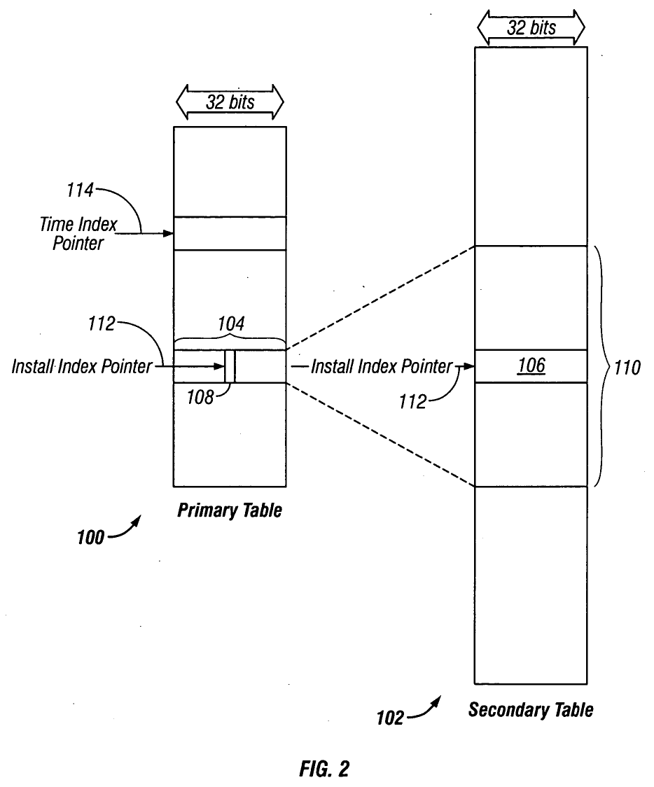

Referring to FIG. 2, data structures representing tables for managing timers are shown. A primary table 100 is stored in the primary memory 38, and a secondary table 102 is stored in the secondary memory 40. At a given time, portions of the primary 100 and secondary 102 tables may also be stored in a cache in the on-chip memory 42. In this example, the primary table 100 has 32-bit wide storage locations, and the secondary table 102 has 64-bit wide storage locations. A storage location 104 in the primary table 100 stores 32 1-bit entries. A storage location 106 in the secondary table 102 stores a single 64-bit entry. There is a one-to-one correspondence between the entries in the primary 100 and secondary 102 tables. The group of 32 entries (including 1-bit entry 108) in the storage location 104 in the primary table 100 correspond to a group 110 of 32 entries in the secondary table 102.

An install index pointer 112 locates corresponding entries in the primary 100 and secondary 102 tables. The five low order bits of the install index pointer 112 locate the entry 108 within the storage location 104, and the high order bits of the install index pointer 112 locate the storage location 104 within the primary table 100. The same install index pointer 112 (high and low order bits) locates an entry 106 in the secondary table 102 corresponding to the entry 108 in the primary table. This type of indexing into the tables enables both corresponding table entries to be accessed by the network processor 26 without having to access multiple pointers.

The 1-bit entries in the primary table are status bits, indicating whether a timer associated with that entry is being used (e.g., status bit=“1”) or is not being used (e.g., status bit=“0”). The corresponding 32-bit entries in the secondary table 102 provide the memory address (e.g., within another portion of the secondary memory 40) of timer information which includes information such as the state of the connection to which the timer belongs, transmit and receive data queues, addresses, and port numbers. This timer information is organized into a “connection descriptor structure” that is located by the “connection address” provided by an entry in the secondary table 102. The value of the install index pointer corresponding to that entry is also stored in the connection descriptor structure. This table arrangement is particularly useful for managing a timer that has the same timeout value for every connection (e.g., the “Delayed Ack” TCP timer). Three primary operations performed by the network processor 26 in managing the timers are installing a timer, expiring (or “timing out”) a timer, and canceling a timer. The network processor 26 handles a request for installing a timer (e.g., for a new connection) by writing information into the primary and secondary tables at locations corresponding to the install index pointer 112.

The network processor 26 uses a time index pointer 114 to locate timers to expire. For timers with the same timeout value, the network processor 26 can increment the install index pointer 112 and the time index pointer 114 based on elapsed time (e.g., as determined by processor clock cycles). At regular time intervals, the pointers are incremented by a single storage location (corresponding to 32 entries). The time index pointer 114 lags the install index pointer 112 by an amount of time that is approximately equal to the timeout value (within the tolerance of the TCP protocol) so that an installed timer will be ready to be expired when the time index pointer 114 reaches the storage location at which the timer was installed. Both tables are circular so that the pointers wrap around to the beginning after reaching the end of the tables. Timers are installed in one part of a table and expired in another part of the table.

For example, if there are 64,000 storage locations in the primary table 100 (corresponding to 64,000 groups in the secondary table 102) and there are 32,000 storage locations between the install index pointer 112 and the time index pointer 114, the pointers increment by one storage location (32 entries) every 6.25 μsec for a timeout value of 200 ms. During this time interval of 6.25 μsec, the install index pointer increments by one entry when a timer is installed.

An exception to the regular incrementing of the install index pointer 114 occurs when the network processor 26 receives more than 32 requests for installing a timer during the 6.25 μsec time interval. If the current storage location is full, a new timer installation request occurring within the time interval triggers the network processor 26 to increment the install index pointer 112 to the next storage location before the end of the time interval and install the new timer in an entry of the next storage location.

A large burst of new timers to install within a short time period can cause the install index pointer 112 to increase by many storage locations. The probability of an overflow (i.e., the install index pointer 112 wrapping around the table to have the same value as the time index pointer 114) can be reduced by using a large table. In this example, if the network processor 26 receives a single burst of one million timer installation requests, the table will not overflow no matter how short the burst is since there are 32×32,000=1,024,000 entries between the install index pointer 112 and the time index pointer before the burst occurs.

Another exception to the regular incrementing of the install index pointer 112 occurs after the network processor 26 has received a burst of installation requests causing the install index pointer 112 to increment beyond its default install offset of 32,000 storage locations ahead of the time index pointer 114. Until the install index pointer 112 returns to its default install offset, the network processor 26 will only increment the install index pointer to the next storage location when the current storage location is full. This allows the install index pointer 112 to recover to its default install offset after a burst.

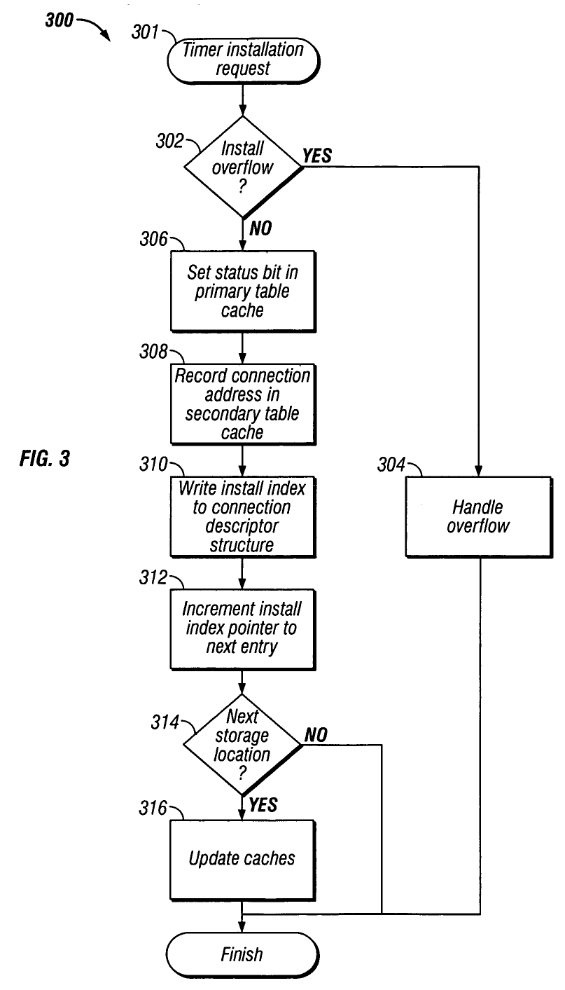

Referring to FIG. 3, a generalized description of an install process 300 includes, receiving 301 a timer installation request, and testing 302 the received timer installation request for a potential overflow condition by testing whether the value of the install index pointer 112 is equal to the value of the time index pointer 114. If the pointers are equal, then the network processor handles 304 the overflow condition with procedures to handle a new timer installation without overwriting previous unexpired timer data. If the testing 302 determines that an overflow does not exist, the process 300 sets 306 a status bit in a primary 32-bit cache in the on-chip memory 42 for an entry (e.g., entry 108) within the current storage location in the primary table 100. The process 300 records 308 a connection address in a secondary 1024-bit cache in the on-chip memory 42. The secondary cache stores the group of entries in the secondary table 102 corresponding to the status bit entries in the primary cache. The process 300 writes 310 the current install index pointer 112 value into the corresponding connection descriptor structure.

The process 300 increments the install index pointer to the next entry and determines 314 whether the next entry has incremented to the next the storage location (indicating that all 32 entries in the current storage location have been used), and if so, the process 300 updates 316 the primary and secondary caches by copying the values in the cache to the primary and secondary memories and using the caches for the entries corresponding to the next storage location. If the next entry remains in the current storage location then the caches are not updated.

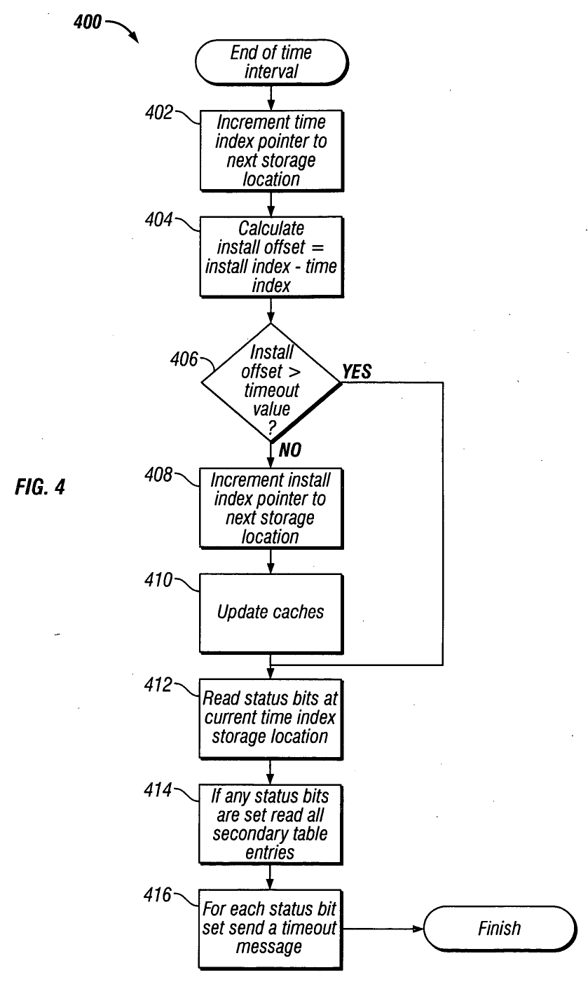

Referring to FIG. 4, a generalized description of a timeout process 400 includes incrementing 402 the time index pointer 114 to locate the next storage location. The process 400 calculates 404 the install offset as the difference between the install index pointer 112 and the time index pointer 114, and determines 406 whether the install offset is greater than the default value (corresponding to the timeout value). If not, the process 400 increments 408 the install index pointer to the next storage location and updates 410 the caches. If the install index offset is greater than the default value then the process 400 does not perform the incrementing 408 and updating 410 to allow the install offset to recover to its default value (e.g., after a burst of installation requests).

The process 400 reads the 32 status bits at the current time index storage location in the primary table 100 in a single read operation. If any of the status bits are set (e.g., status bit=“1”), then the process 400 reads the 32 connection addresses from consecutive storage locations in the secondary table 102 in a single read operation. For each status bit that is set, the process 400 sends a timeout message that includes the corresponding connection address to a designated process (e.g., a TCP process).

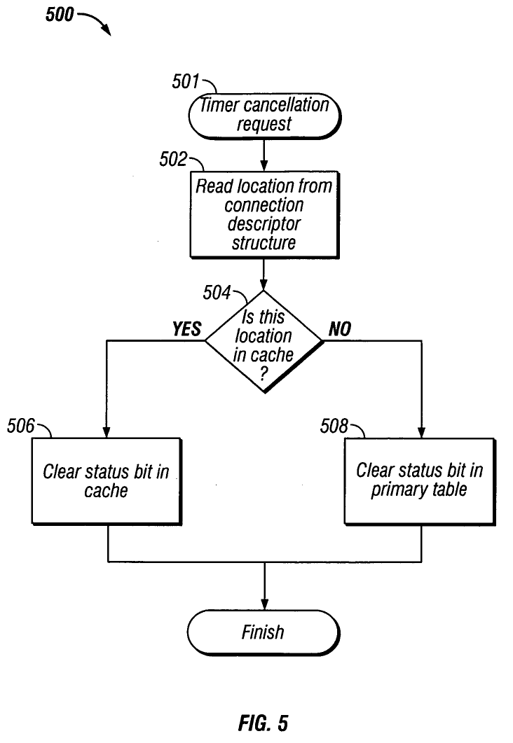

Referring to FIG. 5, a generalized description of a cancel process 500 includes receiving 501 a timer cancellation request that includes the address of the connection descriptor structure associated with the timer to be cancelled. The process 500 reads 502 the location of the status bit for the timer to be cancelled from the connection descriptor structure (previously written 310 by the install process 300). The process 500 determines 504 whether the location of the status bit is currently in the primary cache in the on-chip memory 42 or in the primary memory 38. If the status bit is in the primary cache, the process 500 clears 506 the status bit efficiently with a fast on-chip memory 42 operation. If the status bit is in the primary memory 38, the process 500 clears 508 the status bit with an atomic read-write-modify operation on the primary memory 38 that the can be performed efficiently (e.g., by an SRAM controller).

The network processor 26 can perform timer management efficiently with a small number of off-chip memory accesses for each timer handled. The first 32 timer installation requests in a time interval are handled in the on-chip memory 42. Cache updating is performed in aggregate for 32 entries in a single write operation to each of the primary memory 38 and secondary memory 40. A timeout for any of a group of 32 timers is performed in two read operations (one in primary memory 38 and one in secondary memory 40). A timer cancellation request uses an on-chip memory 42 operation, or one efficient memory operation on the primary memory 38.

The processes described herein can be implemented in digital electronic circuitry, or in computer hardware, firmware, software, or in combinations of them. The processes described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Particular embodiments have been described, however other embodiments are within the scope of the following claims. For example, the operations of the processes can be performed in a different order and still achieve desirable results.

1. A method comprising:
installing a timer by writing a status bit into a first table indexed by a first pointer, and writing a value corresponding to timer information into a second table indexed by the first pointer.

2. The method of claim 1 wherein the value comprises a memory address of a connection descriptor structure.

3. The method of claim 1 wherein the first table stores a plurality of status bits including the status bit and the second table stores a plurality of values corresponding to a like plurality of timers.

4. The method of claim 1 further comprising:
canceling the timer by changing the status bit.

5. The method of claim 1 further comprising:
sending the value to a process to expire the timer.

6. The method of claim 5 wherein expiring the timer comprises:
reading the value;
determining whether the status bit has been changed; and
sending a message including the value to expire the timer if the status has not been changed.

7. The method of claim 6 further comprising:
incrementing the first pointer and a second pointer based on a clock.

8. The method of claim 7 wherein expiring the timer further comprises:
incrementing the second pointer; and
incrementing the first pointer if a difference between the first pointer and the second pointer is smaller than a pre-determined offset.

9. The method of claim 6 wherein reading the value includes reading other values in the second table adjacent to the value.

10. A method comprising:
installing a number of timers during a first time interval; and
expiring a first one of the timers during either a second time interval or a third time interval based on the number of timers installed during the first time interval, with the first time interval ending before the second time interval begins, and the second time interval ending before the third time interval begins.

11. The method of claim 10 wherein the timers have the same expiration time.

12. The method of claim 10 wherein expiring a first one of the timers during either a second time interval or a third time interval based on the number of timers installed during the first time interval comprises
expiring the first one of the timers during the second time interval if the first one of the timers was one of the first N timers to be installed during the first time interval, or expiring the first one of the timers during the third time interval otherwise, where N is a pre-determined number.

13. A computer program product tangibly embodied on a computer readable medium, for managing timers, comprising instructions for causing a computer to:
install a timer by writing a status bit into a first table indexed by a first pointer, and writing a value corresponding to timer information into a second table indexed by the first pointer.

14. The computer program product of claim 13 wherein the first table stores a plurality of status bits including the status bit and the second table stores a plurality of values corresponding to a like plurality of timers.

15. The computer program product of claim 13 further comprising instructions for causing the computer to:
cancel the timer by changing the status bit.

16. The computer program product of claim 13 further comprising instructions for causing the computer to:
send the value to a process to expire the timer.

17. A system comprising:
a host including an input port for receiving data packets and an output port for transmitting data packets;
a memory structure; and
a processor associated with the memory structure the processor configured to
install a timer by writing a status bit into a first table in memory, the first table indexed by a first pointer, and write a value corresponding to timer information into a second table in memory, the second table indexed by the first pointer.

18. The system of claim 17 wherein the processor comprises a microengine array.

19. The system of claim 17 wherein the first table stores a plurality of status bits including the status bit and the second table stores a plurality of values corresponding to a like plurality of timers.

20. The system of claim 17 wherein the processor is further configured to cancel the timer by changing the status bit.

21. The system of claim 17 wherein the processor is further configured to send the value to a process to expire the timer.

22. A computer program product tangibly embodied on a computer readable medium, for managing timers, comprising instructions for causing a computer to:
install a number of timers during a first time interval; and
expire a first one of the timers during either a second time interval or a third time interval based on the number of timers installed during the first time interval, with the first time interval ending before the second time interval begins, and the second time interval ending before the third time interval begins.

23. The computer program product of claim 22 wherein the timers have the same expiration time.

24. The computer program product of claim 22 wherein expiring a first one of the timers during either a second time interval or a third time interval based on the number of timers installed during the first time interval comprises
expiring the first one of the timers during the second time interval if the first one of the timers was one of the first N timers to be installed during the first time interval, or expiring the first one of the timers during the third time interval otherwise, where N is a predetermined number.

25. A system comprising:
a host including an input port for receiving data packets and an output port for transmitting data packets;
a memory structure; and
a processor associated with the memory structure the processor configured to
installing in memory a number of timers during a first time interval; and
expiring a first one of the timers during either a second time interval or a third time interval based on the number of timers installed during the first time interval, with the first time interval ending before the second time interval begins, and the second time interval ending before the third time interval begins.

26. The system of claim 25 wherein the timers have the same expiration time.

27. The system of claim 25 wherein expiring a first one of the timers during either a second time interval or a third time interval based on the number of timers installed during the first time interval comprises
expiring the first one of the timers during the second time interval if the first one of the timers was one of the first N timers to be installed during the first time interval, or expiring the first one of the timers during the third time interval otherwise, where N is a pre-determined number.

28. A processor comprising:
circuitry configured to
install a timer by writing a status bit into a first table in a memory, the first table indexed by a first pointer, and write a value corresponding to timer information into a second table in memory, the second table indexed by the first pointer.

29. The processor of claim 28 wherein the first table stores a plurality of status bits including the status bit and the second table stores a plurality of values corresponding to a like plurality of timers.

30. The processor of claim 28 wherein the processor is further configured to cancel the timer by changing the status bit.

31. A system comprising:
a network host having a network processor;
a TCP offload engine in communication with the network processor; and
a wireless PHY device in communication with the network processor;
wherein the TCP offload engine is configured to
install a timer by writing a status bit into a first table in a memory, the first table indexed by a first pointer, and write a value corresponding to timer information into a second table in memory, the second table indexed by the first pointer.

32. The system of claim 31 wherein the first table stores a plurality of status bits including the status bit and the second table stores a plurality of values corresponding to a like plurality of timers.

33. The system of claim 32 wherein the TCP offload engine is further configured to cancel the timer by changing the status bit.

34. A method comprising:
receiving a first data packet from a source;
installing a timer by writing a status bit into a first table in a memory, the first table indexed by a first pointer, and writing a value corresponding to timer information into a second table in memory, the second table indexed by the first pointer; and
sending a second data packet to the source for acknowledging receipt of the first data packet, after the timer has expired.

35. The method of claim 34 wherein the first table stores a plurality of status bits including the status bit and the second table stores a plurality of values corresponding to a like plurality of timers.

36. The method of claim 34 further comprising canceling the timer by changing the status bit.
